(19) United States
(12) Patent Application Publication
(10) Pub. No.: US 2008/0041643 A1
(43) Pub. Date: Feb. 21, 2008

(54) Wind-power vehicle aka WPV

(76) Inventor: Tony N. Khalife, Millbury, MA (US)

Correspondence Address: Tony N. Khalife, 7 Millbury Terrace, Millbury, MA, 01527, US

(21) Appl. No.: 11/800,950

(22) Filed: May 8, 2007

Related U.S. Application Data
(60) Provisional application No. 60/838,931, filed on Aug. 17, 2006.

(51) Int. Cl. B60L 8/00; F03D 9/02

(52) U.S. Cl. 180/2.2; 290/55

(57) ABSTRACT

A wind turbine 10 will be used as a propulsion system for a vehicle and will keep it in motion after initial start and take off by a battery pack 14. The air and/or wind being forced on the vehicle as a result of its motion will rotate the turbine's blades 10A. The energy will cause a low-speed shaft 10B to rotate, which will in turn, cause a set of gears 10C to spin. The gears 10C will then cause a high-speed shaft 10D to rotate; this will allow the electrical generator 10E to generate electricity. The electricity generated will travel through a pair of conductive wires 12 to a set of battery packs 14. The energy will recharge the set of battery packs 14; this will allow for enough continuous energy to keep the vehicle in motion for the desired time period.

### CROSS-REFERENCE TO RELATED APPLICATIONS

This application claims the benefit of provisional patent application Ser. No. 60/838,831, filed Aug. 21, 2006 by the present inventors.

### FEDERALLY SPONSORED RESEARCH

Not Applicable

### SEQUENCE LISTING OR PROGRAM

Not Applicable

### BACKGROUND OF THE INVENTION

1. Field of Invention

This invention generally relates to vehicles, specifically to a unique propulsion system involving renewable energy resources.

2. Prior Art

Previously, vehicles were made with combustion engines. These combustion engines are posing some problems. The source of propulsion for these combustion engines, petroleum and diesel, effectively drives the car forward. However, this source of energy is nonrenewable and poses some environmental problems. The environmental problems result from the multiple emissions which are produced, such as hydrocarbons, nitrous oxides, and carbon monoxide. These pollutants from vehicles contribute to the formation of ground-level ozone and acid rain. Also, carbon monoxide provides health problems such as impairing mental function and reducing the amount of oxygen in one's bloodstream.

This problem has been partially solved with the invention of electrical cars. Electric cars do not make use of petroleum. Instead, these cars contain an electric motor and are battery powered. The batteries, however, must be recharged every few hours. This was the downside to this invention. Although it was environmentally friendly, it was not practical. The car was not available for the periods of time that users needed it. Also, the electric car has limited range (in relation to distance from home) and require charge stations to become of use again.

### OBJECTS AND ADVANTAGES

Accordingly, several objects and advantages of our invention are:
a. to provide a vehicle which functions with a renewable energy source;
b. to provide a vehicle which is environmentally friendly, releasing no pollutants into the air;
c. to provide a vehicle with the ability to travel limitless distances, without the use of charge stations.

Further objects and advantages are the ability of this vehicle to recharge its batteries while in use, which is simple and efficient. In addition, this vehicle will work with the same car frame and body used in current models. However, this vehicle will be cheaper than the standard vehicle because it does not require motor oil nor does it have an engine or transmission. Without these extra parts, there are fewer parts to break down making the maintenance for the vehicle less expensive. Further objects and advantages will become apparent from the ensuing description and drawings.

### SUMMARY

In accordance with the present invention a vehicle comprises a wind turbine for a propulsion system having a renewable energy source. The turbine generates electricity through the motion of the vehicle and recharges the batteries to keep the vehicle in motion.

### DRAWINGS—FIGURES

FIG. 1 shows the internal components of our vehicle.

FIG. 2 is a front perspective view of vehicle.

FIG. 3 is a top perspective view vehicle.

### DRAWINGS—REFERENCE NUMERALS

| | | | |
|---|---|---|---|
| 10 | wind turbine | 10A | blade |
| 10B | low-speed shaft | 10C | gears |
| 10D | high-speed shaft | 10E | electrical generator |
| 12 | wire | 14 | battery packs |
| 16 | grill | | |

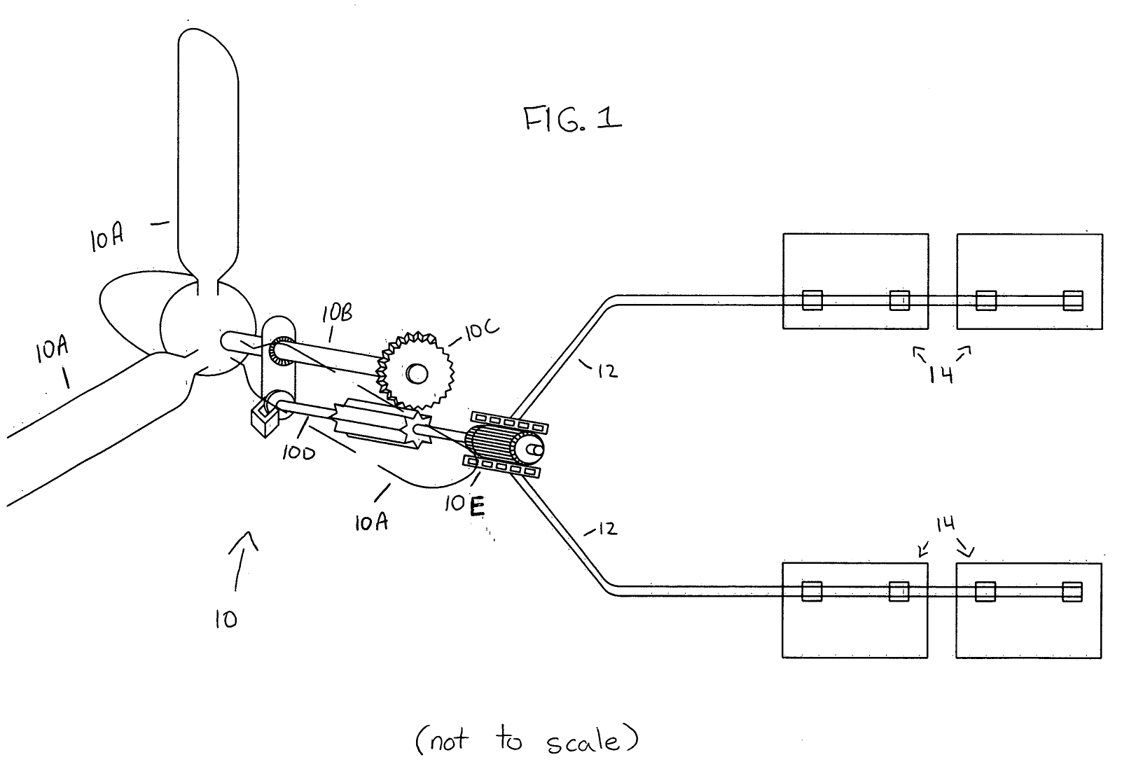

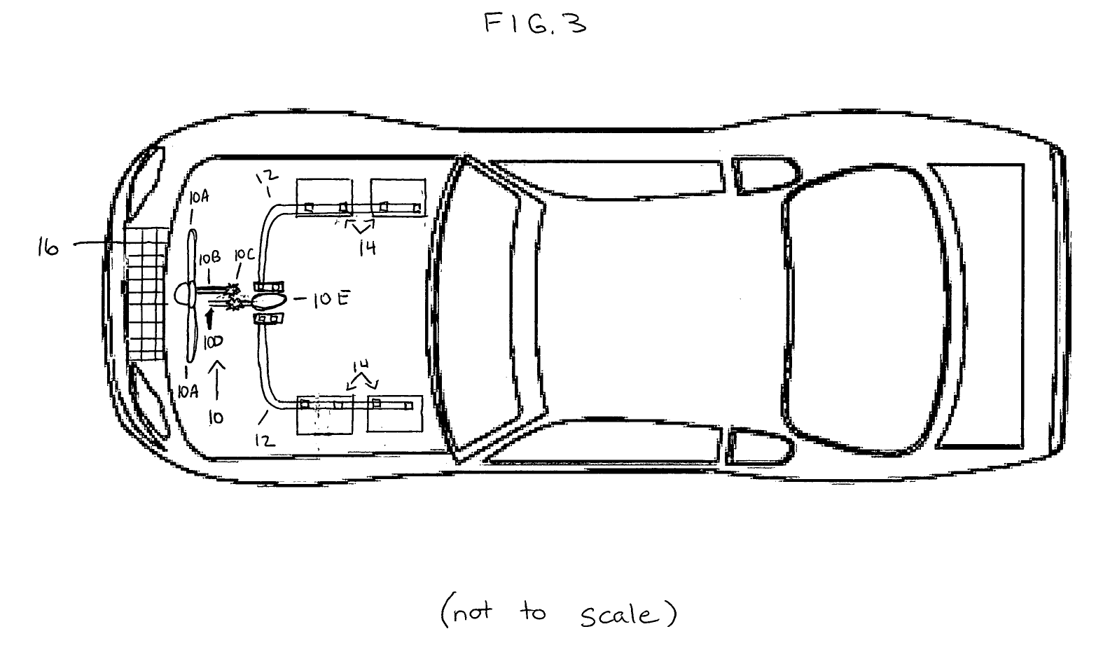

### DETAILED DESCRIPTION—FIGS. 1 AND 3—PREFERRED EMBODIMENT

A preferred embodiment of the internal components of the present invention is illustrated in FIG. 1. A top perspective view of the present invention is illustrated in FIG. 3. The vehicle has a protective grill 16 consisting of a metallic material with tiny grates (FIG. 3); this leads to a wind turbine 10. In the preferred embodiment (FIG. 1), the wind turbine 10 consists of a set of blades 10A, a low-speed shaft 10B, a set of gears 10C, a high-speed shaft 10D, and an electrical generator 1E. The blades 10A are affixed to the low speed shaft 10B. The low-speed shaft 10B is connected to the set of gears 10C, which turn jointly. The last of the gears 10C is connected to the high-speed shaft 10D. These two also turn as a group. Lastly, the shaft 10D is linked to the electrical generator 10E.

In the preferred embodiment (FIG. 1), the electrical generator 10E is connected to a pair of conductive wires 12. The pair of wires 12 link a set of battery packs 14. The battery packs 14 can consist of, but are not limited, to two batteries. Each of the batteries within the battery pack 14 is joined by the conductive wires 12. The battery packs 14 are then connected to any of the components of a vehicle that require electricity i.e. wheels, radio, etc. The blades 10A, low-speed shaft 10B, the gears 10C, the high-speed shaft 10D, the wires 12, and the battery packs 14 can vary in sizes and dimensions depending on the needs of different vehicles.

### Operation—FIGS. 1, 2, 3

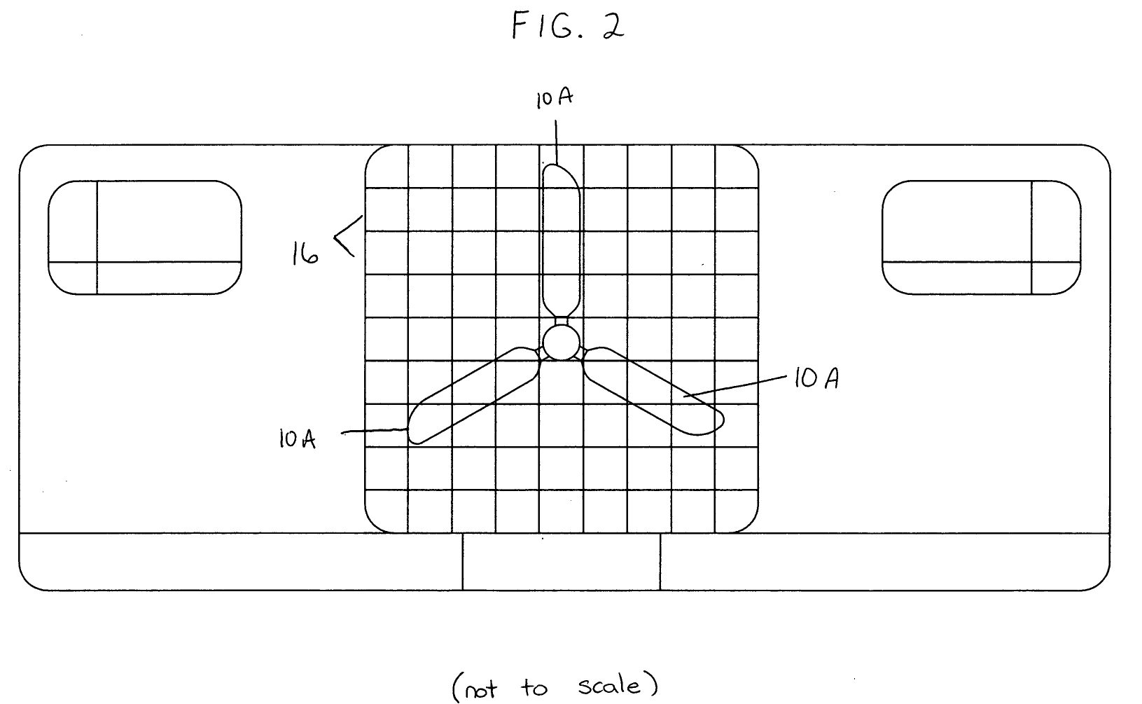

The manner of using the wind turbine to power a vehicle is almost identical to the method by which electric cars are powered in present times. In the FIG. 2, the grill 16 is a protective measure. It consists of tiny metallic grates which allow only air to flow in. The grill 16 is to prevent any kind of harm to any creature that attempts to come in contact with the blades of the turbine.

After the vehicle's initial start, with use of the battery packs 14, the vehicle is in motion. In FIG. 1 and FIG. 3, the wind turbine 10 is the main component of the vehicle and is the propulsion system of the vehicle. The wind turbine 10 allows the vehicle to stay in motion. The wind turbine's blades 10A begin to rotate in a 360 degree manner as a result of the air's force, which is the product of the moving vehicle. An example of this force is on any interstate; when a person holds his or her hand out the window on a highway, the person experiences the force of air. As a result of the rotating blades 10A, the low-speed shaft 10B also begins to turn at a rate of 30 to 60 rotations per minute. The rotation of the low-speed shaft 10B causes the spinning of the gears 10C. The gears 10C magnify the rotation of the low-speed shaft 10B and transfer this to the high-speed shaft 10D. The high-speed shaft 10D rotates at a rate of 1200-1500 rpm (rotations per minute). The high-speed shaft 10D is connected to the electrical generator 1E.

The electrical generator 10E converts the mechanical energy (rotation of the high-speed shaft 10D) into electrical energy. This electrical energy travels through the conductive wires 12 to the battery packs 14. The electricity generated is used to recharge the battery packs 14. The motion of the vehicle allows the wind turbine 10 to function, which creates electrical energy that recharges the battery packs 14 within the vehicle.

### Advantages

From the description above, a number of advantages of our wind-powered vehicle become evident:
a. to provide a vehicle which functions with a renewable energy source (the wind);
b. to provide a vehicle which is environmentally friendly, releasing no pollutants into the air;
c. to provide a vehicle with the ability to travel limitless distances, without the use of charge stations;
d. to provide a vehicle which can recharge its power supply while in use;
e. to provide a vehicle that can adapt to the current frame and body of present-day cars;
f. to provide a vehicle that will be cheaper to maintain due to the fewer number of parts and does not require oil to be regularly changed.

### Conclusion, Ramifications, and Scope

Accordingly, the reader will see that the wind-powered vehicle is an invention than can be quite efficient, environmentally friendly, and less costly for the average person. In addition, this vehicle can be manufactured with relative ease because it can adapt to almost any vehicle type. The motion of the vehicle allows it to stay in motion; the wind causes the turbine to generate electricity which keeps the batteries charged. The charged batteries provide energy for the rest of the vehicle to function.

Although the description above contains many specifications, these should not be construed as limiting the scope of the invention but as merely providing illustrations of some of the presently preferred embodiments of this invention. For example, the turbine and blades can have many sizes and can adapt to any other type of vehicle, such as a semi-tractor trailer; the number of batteries can be increased or decreased depending on how much energy the vehicle is to use.

Thus the scope of the invention should be determined by the appended claims and their legal equivalents, rather than by the examples given.

We claim:

1. A means of transportation with a renewable energy, comprising:
a. a means for harnessing air and wind power for propulsion,
b. a storage device to hold energy harnessed,
c. a means for transferring energy harnessed to said storage device,
whereby said means for harnessing energy relocates energy through said means for transferring energy to said storage device to hold energy harnessed.

2. The means of transportation of claim 1 wherein said means is a vehicle.

3. The vehicle of claim 2 wherein a grill 12 protects objects from interfering with said vehicle's inner components.

4. The means for harnessing of claim 1 wherein said means is a wind turbine 10.

5. The wind turbine of claim 4 consisting of a blade 10A.

6. The blade 10A of claim 5 whereby it rotates due to wind blowing over it.

7. The wind turbine of claim 4 consisting of a low-speed shaft 10B.

8. The low-speed shaft 10B of claim 7 whereby it rotates at a rate of 30-60 rotations per minute due to spinning of said blade 10A.

9. The wind turbine of claim 4 consisting of a set of gears 10C.

10. The gears 10C of claim 9 whereby it transfers energy from said low-speed shaft 10B to a high-speed speed 10D and increases rotational speed.

11. The wind turbine of claim 4 consisting of said high-speed shaft 10D.

12. The high-speed shaft 10D of claim 11 whereby it drives an electrical generator 10E.

13. The wind turbine of claim 4 consisting of said electrical generator 10E.

14. The generator 10E of claim 13 whereby it converts mechanical energy to electrical energy.

15. The storage device of claim 1 wherein said storage device is a battery pack 14.

16. The battery pack of claim 15 consisting of two twelve volt batteries.

17. The means of transferring energy of claim 1 wherein it is a wire 12.

18. The wire 12 of claim 17 whereby it conducts electricity and transfers energy produced by said electrical generator 10E to said battery pack 14.
